(19) United States
(12) Patent Application Publication
(10) Pub. No.: US 2019/0154147 A1
(43) Pub. Date: May 23, 2019

(54) NON-SYNCHRONOUS SHIFT CONTROL METHOD AND ASSEMBLIES FOR CONTINUOUSLY VARIABLE TRANSMISSIONS

(71) Applicant: DANA LIMITED, MAUMEE, OH (US)

(72) Inventors: CHARLES B. LOHR, III, JONESTOWN, TX (US); TRAVIS J. MILLER, CEDAR PARK, TX (US); SEBASTIAN J. PETERS, CEDAR PARK, TX (US); WILLIAM F. WALTZ, TOLEDO, OH (US)

(73) Assignee: DANA LIMITED, MAUMEE, OH (US)

(21) Appl. No.: 16/091,361

(22) PCT Filed: Apr. 5, 2017
(86) PCT No.: PCT/US2017/026041

§ 371 Date: Oct. 4, 2018

Related U.S. Application Data
(60) Provisional application No. 62/318,379, filed on Apr. 5, 2016.
(60) Provisional application No. 62/343,297, filed on May 31, 2016.

(51) Int. Cl. F16H 61/70; F16H 37/02; F16H 15/50; F16H 3/66; F16H 61/00

(52) U.S. Cl. CPC F16H 61/702; F16H 37/022; F16H 15/503; F16H 2003/445; F16H 61/0021; F16H 2037/023; F16H 3/666

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly having an array of balls, a planetary gear set coupled thereto and an arrangement of rotatable shafts with multiple gears and clutches that extend the ratio range of the variator. In some embodiments, clutches are coupled to the gear sets to enable shifting of gear modes. In some embodiments, the speed ratio of the ball variator is adjusted in concert with the adjustment of clutches.

### RELATED APPLICATIONS

The present application claims the benefit of U.S. Provisional Application No. 62/318,379 filed on Apr. 5, 2016 and U.S. Provisional Application No. 62/343,297 filed on May 31, 2016, which are incorporated herein by reference in its entirety.

### BACKGROUND

A driveline including a continuously variable transmission allows an operator or a control system to vary a drive ratio in a stepless manner, permitting a power source to operate at its most advantageous rotational speed.

### SUMMARY

Provided herein is a method for controlling a continuously variable transmission, the method including: providing a continuously variable transmission having a first rotatable shaft operably coupleable to a source of rotational power, the first rotatable shaft forming a main axis; a continuously variable device (CVD), wherein the CVD is a ball variator assembly having a first traction ring assembly and a second traction ring assembly in contact with a plurality of balls, wherein each ball of the plurality of balls has a tiltable axis of rotation and wherein the ball variator assembly is coaxial with the main axis; a multiple speed gearbox having a number of selectable speed ranges; a CVD ratio actuator operably coupled to the CVD; a gearbox actuation system operably coupled to the multiple speed gearbox; coupling the gearbox actuation system to the CVD ratio actuator; and coordinating a change in speed ratio of the CVD to a change in the gearbox actuation system.

Provided herein is a method of controlling a continuously variable transmission, the method including the steps of providing a continuously variable transmission having a first rotatable shaft operably coupleable to a source of rotational power, the first rotatable shaft forming a main axis; a continuously variable device (CVD) having a first traction ring assembly and a second traction ring assembly in contact with a plurality of balls, wherein each ball of the plurality of balls has a tiltable axis of rotation, the CVD is coaxial with the main axis; a multiple speed gearbox having a number of selectable speed ranges; a CVD ratio actuator operably coupled to the CVD; a gearbox actuation system operably coupled to the multiple speed gearbox; receiving a plurality of signals indicative of a current operation condition of the CVD and the multiple speed gearbox; commanding a change in the operating condition of the multiple speed gearbox based at least in part on the plurality of signals received; commanding a change in the CVD operating condition based at least in part on the operating condition of the multiple speed gearbox.

Provided herein is a continuously variable transmission having a first rotatable shaft operably coupleable to a source of rotational power; a second rotatable shaft arranged parallel to the first rotatable shaft; a variator assembly having a first traction ring assembly and a second traction ring assembly in contact with a plurality of balls, wherein each ball of the plurality of balls has a tiltable axis of rotation, the variator assembly is coaxial with the first rotatable shaft; a first planetary gear set having a first ring gear operably coupled to the second traction ring assembly, a first planet carrier operably coupled to the first rotatable shaft, and a first sun gear; and a second planetary gear set having a second ring gear operably coupled to the second rotatable shaft, a second planet carrier operably coupled to the first traction ring assembly, and a second sun gear operably coupled to ground.

Provided herein is a continuously variable transmission having a first rotatable shaft operably coupleable to a source of rotational power; a second rotatable shaft arranged parallel to the first rotatable shaft; a variator assembly having a first traction ring assembly and a second traction ring assembly in contact with a plurality of balls, wherein each ball of the plurality of balls has a tiltable axis of rotation, the variator assembly is coaxial with the first rotatable shaft; a planetary gear set a ring gear, a planet carrier operably coupled to the second traction ring assembly, and a sun gear operably coupled to the first traction ring assembly; a first clutch arranged coaxial with the second rotatable shaft, the first clutch operably coupled to the ring gear; a second clutch coaxial with the second rotatable shaft, the second clutch operably coupled to the ring gear; a third clutch coaxial with the second rotatable shaft, the third clutch operably coupled to the second clutch; a fourth clutch coaxial with the second rotatable shaft; a first gear set having a first fixed torque ratio, the first gear set coaxial with the second rotatable shaft, the first gear set operably coupled to the first clutch, the second clutch, and the fourth clutch; and a second gear set having a second fixed torque ratio, the second gear set coaxial with the second rotatable shaft, the second gear set operably coupled to the first gear set, the second gear set operably coupled to the third clutch.

Provided herein is a continuously variable transmission having a first rotatable shaft operably coupleable to a source of rotational power; a continuously variable device operably coupled to and coaxial to the first rotatable shaft, the continuously variable device including a variator assembly having a first traction ring assembly and a second traction ring assembly in contact with a plurality of balls, wherein each ball of the plurality of balls has a tiltable axis of rotation, the variator assembly is coaxial with the first rotatable shaft; a second coaxial rotatable shaft operably coupled to the continuously variable device; and a multiple speed gearbox operably coupled to the second rotatable shaft.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a block diagram of a transmission having a continuously variable device and a multiple speed gearbox.

FIG. 5 is a block diagram of a transmission control system that is used with the transmission of FIG. 4.

FIG. 6 is a flow chart depicting a control process implemented in the transmission control system of FIG. 5.

FIG. 7 is a flow chart depicting another control process implemented in the transmission control system of FIG. 5.

FIG. 8 is a schematic diagram of a continuously variable transmission having a continuously variable device and a multiple speed gearbox.

FIG. 9 is a schematic diagram of a continuously variable transmission having a continuously variable device and a multiple speed gearbox.

FIG. 10 is a table depicting operating modes of the continuously variable transmission depicted in FIG. 9.

FIG. 11 is a schematic diagram of another continuously variable transmission having a continuously variable device and a multiple speed gearbox.

FIG. 12 is a table depicting operation modes of the continuously variable transmission depicted in FIG. 11.

FIG. 13 is a schematic diagram of yet another continuously variable transmission having a continuously variable device and multiple speed gearbox.

FIG. 14 is a table depicting operating modes of the continuously variable transmission depicted in FIG. 13.

FIG. 15 is a schematic diagram of yet another continuously variable transmission having a continuously variable device and multiple speed gearbox.

FIG. 16 is a table depicting operating modes of the continuously variable transmission depicted in FIG. 15.

FIG. 17 is a schematic diagram of yet another continuously variable transmission having a continuously variable device and multiple speed gearbox.

FIG. 18 is a table depicting operating modes of the continuously variable transmission depicted in FIG. 17.

FIG. 19 is a schematic diagram of a continuously variable device having a planetary gear set used as a powersplit.

FIG. 20 is a schematic diagram of a continuously variable device having two planetary gear sets used as a powersplit.

FIG. 21 is a schematic diagram of another continuously variable device having two planetary gear sets used as a powersplit.

FIG. 22 is a schematic diagram of yet another continuously variable device having two planetary gear sets used as a powersplit.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments include several novel features, no single one of which is solely responsible for its desirable attributes or which is essential to practicing the preferred embodiments described.

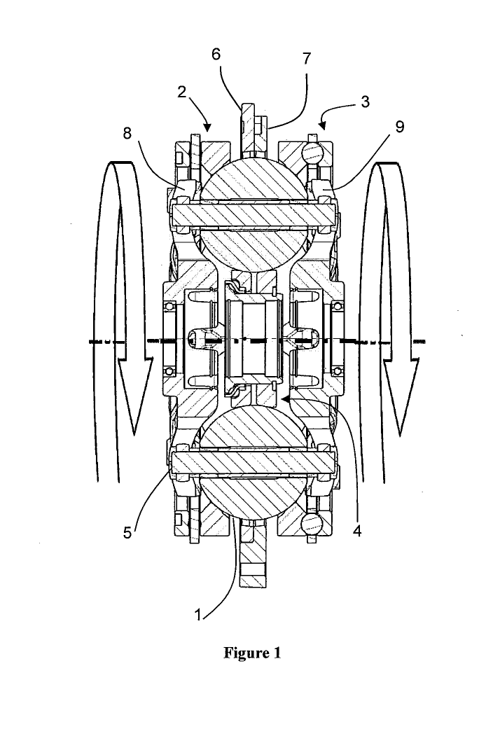

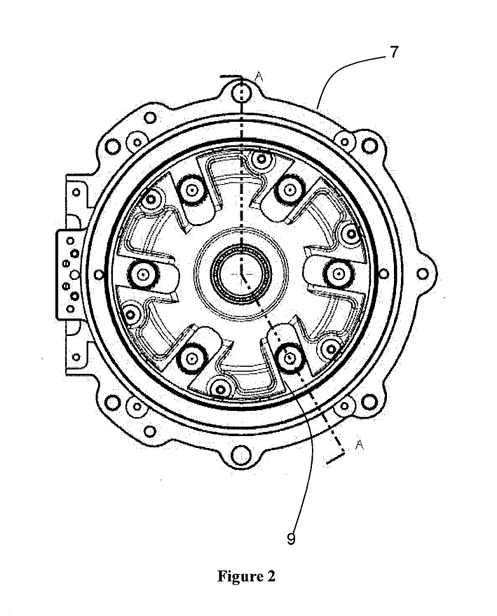

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

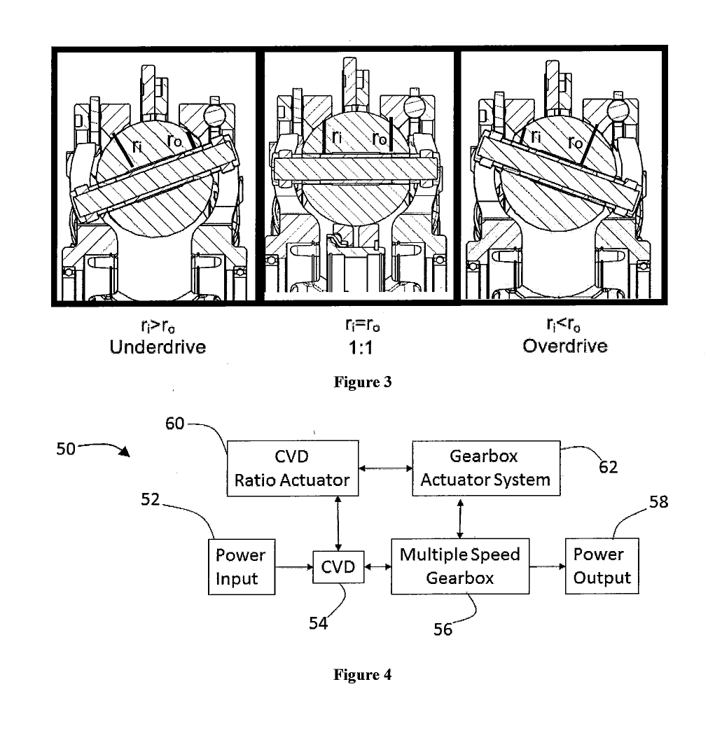

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

As used herein, “creep” or “slip” is the discrete local motion of a body relative to another and is exemplified by the relative velocities of rolling contact components such as the mechanism described herein. “Creep” is characterized by the slowing of the output because the transmitted force is stretching the fluid film in the direction of rolling. As used herein, the term “ratio droop” refers to the shift of the tilt angle of the ball axis of rotation (sometimes referred to as the ratio angle or gamma angle) due to a compliance of an associated control linkage in proportion to a control force that is in proportion to transmitted torque, wherein the compliance of the control linkage corresponds to a change in the skew angle of the ball axis of rotation. As used herein, the term “load droop” refers to any operating event that reduces the ratio of output speed to input speed as transmitted torque increases. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source could be fueled by energy sources including hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission including this technology.

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor reads information from, and writes information to, the storage medium. In the alternative, the storage medium could be integral to the processor. The processor and the storage medium could reside in an ASIC. For example, in one embodiment, a controller for use of control of the IVT includes a processor (not shown).

Turning now to FIG. 4, in one embodiment, a transmission 50 includes a power input interface 52 configured to transmit power from a source of rotational power (not shown). The transmission 50 includes a continuously variable device (CVD) 54 coupled to the power input interface 52. In some embodiments, the CVD 54 includes a variator such as the one described in FIGS. 1-3. The transmission 50 includes a multiple speed gearbox 56 coupled to the CVD 54. In some embodiments, the multiple speed gearbox 56 is configured to have more than one fixed ratio gear ratios. Each gear ratio configured to be selectively engaged by, for example, clutch devices. It should be appreciated that the multiple speed gearbox 56 is optionally configured with well-known multiple speed transmissions such as, but not limited to, the General Motors 4L60/4L80 transmission, the Ford Motor Company 4R70 and other well-known multiple speed automatic transmissions. In some embodiments, the multiple speed gearbox 56 is coupled to a power output interface 58. The CVD 54 is provided with a CVD ratio actuator 60. In some embodiments, the CVD ratio actuator 60 is an electronically controlled actuator such as an electric motor or solenoid controlled hydraulic valves. The CVD ratio actuator 60 is configured to couple to the CVD 54 and provide controlled adjustment of the speed ratio of the CVD 54. The multiple speed gearbox 56 is provided with a gearbox actuation system 62.

In some embodiments, the gearbox actuation system 62 is an electronically controlled hydraulic, mechanical, or electro-mechanical system configured to selectively engage power paths of fixed ratios within the multiple speed gearbox 56. In some embodiments, the CVD ratio actuator 60 is in electrical and/or hydraulic communication with the multiple speed gearbox 56. For example, the CVD ratio actuator 60 is optionally configured to be hydraulically coupled to the gearbox actuation system 62 to thereby coordinate changes in speed ratio of the CVD 54 with the gear selection in the multiple speed gearbox 56. In some embodiments, the CVD ratio actuator 60 is equipped with a sensor (not shown) configured to provide a signal indicative of the force or torque transmitted on the first carrier member 6, for example. For example, the sensor used is a pressure sensor, a strain gauge, or a current sensor, dependent upon the type of actuator chosen for the CVD ratio actuator 60. In some embodiments, the coupling between the CVD ratio actuator 60 and the gearbox actuation system 62 includes a force limiter device (not shown) or other mechanical fuse devices configured to provide a proportional regulated physical feedback between the gearbox actuation system 62 and the CVD ratio actuator 60.

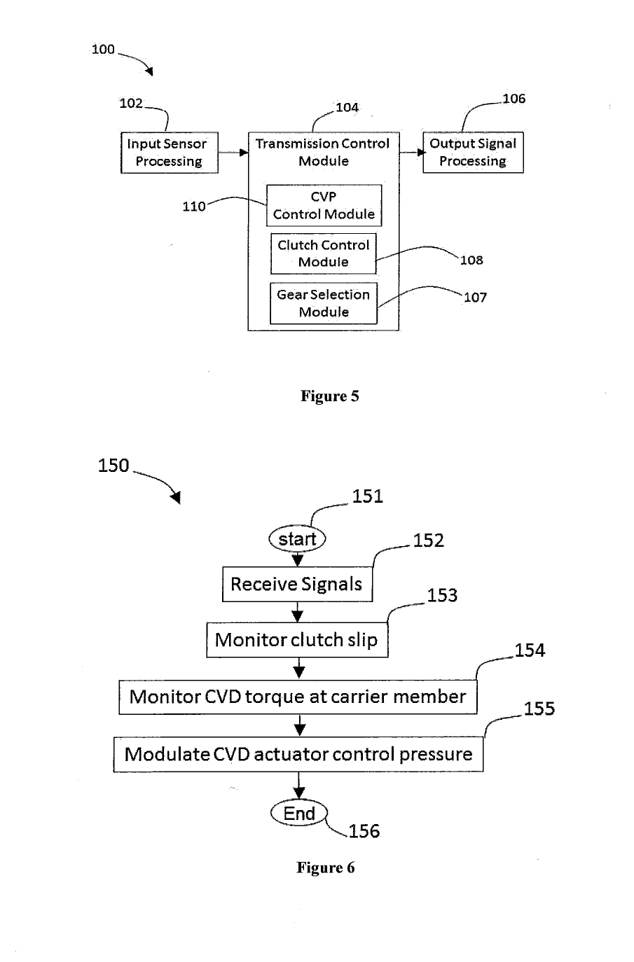

Referring now to FIG. 5, in one embodiment, a transmission controller 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a gear selection sub-module 107 and a clutch control sub-module 108 that are programmed to execute control over clutches or similar devices within the transmission. In some embodiments, the gear selection sub-module 107 is configured to coordinate selection of a desired gear ratio for the transmission. For example, the gear selection sub-module 107 is optionally configured to coordinate pre-selection of synchronizer clutches or other selectable torque transmitting devices. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. One sub-module included in the CVP control sub-module 110 is described herein.

Referring now to FIG. 6, in some embodiments, the transmission controller 100 is configured to execute a control process 150 that begins at a start state 151 and proceeds to a block 152 where a number of signals are received. In some embodiments, the signals are indicative of a current CVD speed ratio, a vehicle speed, an accelerator pedal position, and a current transmission operating mode, and a variety of signals from sensors equipped in the multiple speed gearbox 56, among others. The control process 150 proceeds to a block 153 that is configured to monitor clutches equipped in the multiple speed gearbox 56. In some embodiments, the block 153 is configured to determine if a clutch is experiencing a slip condition, or a condition in which the capacity for the clutch to hold an engaged position is overcome by torque transmitted through the multiple speed gearbox 56. The control process proceeds to block 154 which is configured to monitor the operating conditions of the CVD 54, for example. In some embodiments, the block 154 evaluates the reaction torque on the carrier member. It should be appreciated that the reaction torque on the carrier member of the type described in FIGS. 1-3 is indicative of the output torque transmitted through the CVD 54. The control process 150 proceeds to a block 155 where control commands are generated to modulate the CVD ratio actuator 60 based at least in part on the evaluation of clutch slip determined in the block 153 and the evaluation performed in the block 154. The control process ends at a block 156, after the commands to modulate the CVD ratio actuator 60 are generated.

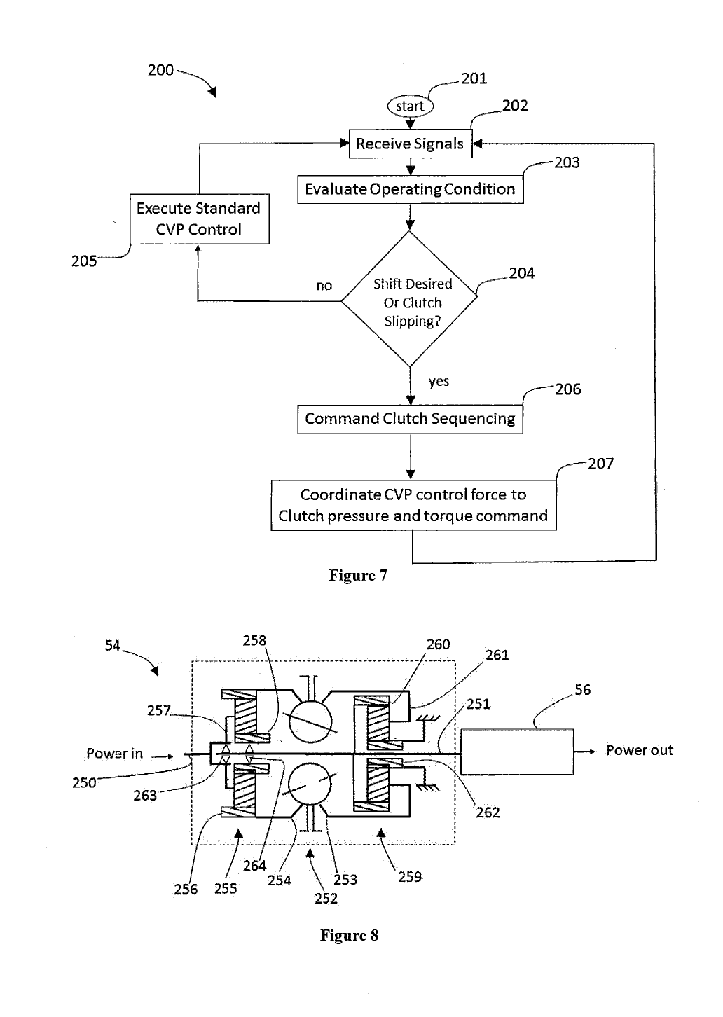

Turning now to FIG. 7, in some embodiments, the transmission controller 100 is configured to implement a control process 200. The control process 200 begins at a start state 201 and proceeds to a block 202 where signals are received. In some embodiments, the signals are indicative of a current CVD speed ratio, a vehicle speed, an accelerator pedal position, and a current transmission operating mode, among others. The control process 200 proceeds to a block 203 where a current operating condition of the transmission, for example the transmission 50, is determined. In some embodiments, the current operating condition of the transmission is indicated by a number of measured, calculated, or otherwise inferred signals. The control process 200 proceeds to an evaluation block 204 where the current operating condition is evaluated to determine if a shift is desired in the multiple speed gearbox 56. In some embodiments, the evaluation block 204 evaluates a clutch slip condition. If the result of the evaluation block 204 is negative, in other words a shift in the multiple speed gearbox 56 is not desired and there are no indication of a clutch slip, the control process 200 proceeds to a block 205 where control processes executed in the CVP control module 110 are executed. If the result of the evaluation block 204 is positive, in other words a shift is desired or a clutch is experiencing slip, the control process 200 proceeds to a block 206 where commands for sequencing clutches equipped in the multiple speed gearbox 56 are determined and passed to other modules of the transmission controller 100. In some embodiments, the commands determined in the block 206 are executed in the gear selection module 107 or the clutch control module 108. The control process 200 proceeds to a block 207 where a control force of the CVD ratio actuator 60, for example, is determined based at least in part on a clutch control pressure signal and a torque command signal. In some embodiments, the clutch control pressure is determined in the block 206. In some embodiments, the clutch control pressure is a signal determined is another module of the transmission controller 100 and received in the block 202. In some embodiments, the torque command signal is determined in another module of the transmission controller 100 and received at the block 202.

Referring now to FIG. 8, in some embodiments, the CVD 54 is provided with a first rotatable shaft 250 configured to receive a rotational power. The CVD 54 includes a second rotatable shaft 251 arranged coaxially with the first rotatable shaft 250 to thereby form a main axis of the CVD 54. In some embodiments, the second rotatable shaft 251 is configured to transmit a rotational power to the multiple speed gearbox 56. The CVD 54 includes a variator (CVP) 252 arranged coaxially with the main axis. In some embodiments, the variator 252 is similar to the variator depicted in FIGS. 1-3. The variator 252 includes a first traction ring assembly 253 and a second traction ring assembly 254 in contact with a number of balls. In some embodiments, the CVT 54 includes a first planetary gear set 255 having a first ring gear 256, a first planet carrier 257, and a first sun gear 258. The first planet carrier 257 is operably coupled to the first rotatable shaft 250. The first ring gear 256 is operably coupled to the second traction ring assembly 254. In some embodiments, the CVD 54 includes a second planetary gear set 259. The second planetary gear set 259 includes a second ring gear 260, a second planet carrier 261, and a second sun gear 262. The second sun gear 262 is grounded to a non-rotatable member of the transmission (not shown). The second planet carrier 261 is operably coupled to the first traction ring assembly 253. The second ring gear 260 is coupled to the second rotatable shaft 251. In some embodiments, the second planetary gear set 259 is configured as a simple gear set having two meshing gears. In some embodiments, the CVD 54 includes a first one-way clutch 263 coupled to the second rotatable shaft 251 and the first planet carrier 257. The CVD 54 includes a second one-way clutch 264 coupled to the second rotatable shaft 251 and the first sun gear 258.

As used here the term “one way clutch” refers to a mechanical diode. A simple one way clutch will transmit torque in only one direction. If torque is applied in the second direction the clutch will freely slip. Many one way clutches are made by replacing round rolling elements in a roller bearing with elements that have an elliptical cross section. Furthermore, the elliptical elements are preset such that they may rotate a limited amount in only one direction without causing a binding action. When the inner race rotates in the first direction, relative the outer race, it will cause the elliptical elements to rotate a few degrees until the radial space between the inner and outer races limits further rotation. When the elliptical elements become wedged into the radial space the inner and outer races may transmit torque in the first direction as any relative motion between the races will only serve to increase the binding action. In contrary, when the inner race rotates in the second direction, relative the outer race, any rotation of the elliptical elements in the following direction will only reduce contact between the elliptical elements and the inner, outer or both elements and no torque may be transmitted.

It should be appreciated that the continuously variable device depicted in FIG. 8 is shown as an illustrative example. Other configurations of powersplit variator devices are optionally configured and implemented in the transmission 50.

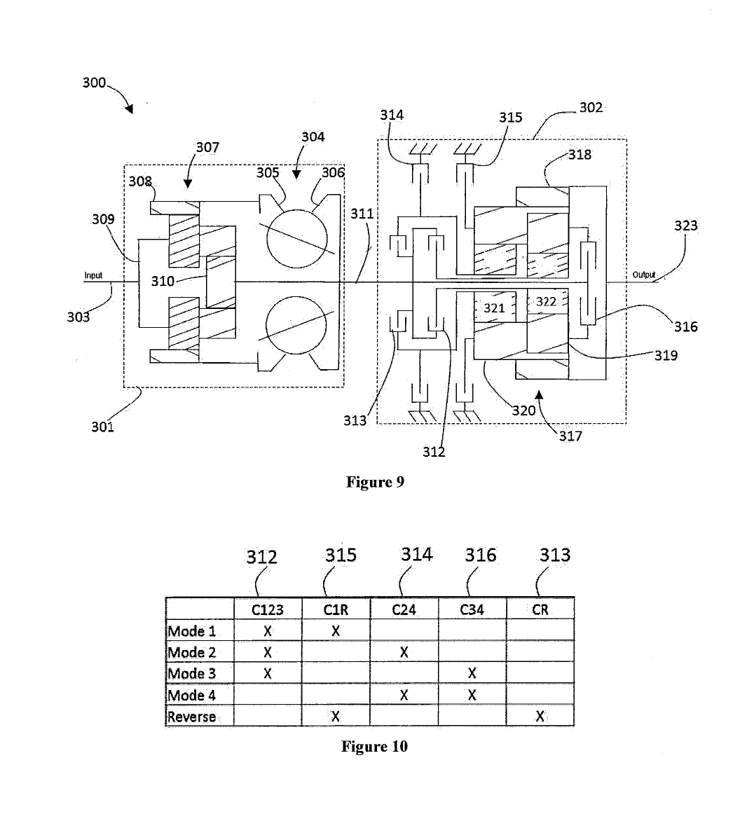

Referring now to FIG. 9, in some embodiments, a continuously variable transmission (CVT) 300 includes a continuously variable device 301 operably coupled to a multiple speed gearbox 302. The CVT 300 is provided with a first rotatable shaft 303 adapted to operably couple to a source of rotatable power (not shown). The continuously variable device 301 includes a variator 304 having a first traction ring assembly 305 and a second traction ring assembly 306. In some embodiments, the variator 304 is configured such as the variator depicted in FIGS. 1-3. The continuously variable device 301 includes a first planetary gear set 307 having a first ring gear 308, a first planet carrier 309, and a first sun gear 310. The first ring gear 308 is operably coupled to the first traction ring assembly 305. The first planet carrier 309 is operably coupled to the first rotatable shaft 303. The first sun gear 310 is operably coupled to the second traction ring assembly 306. In some embodiments, the first sun gear 310 is operably coupled to a second rotatable shaft 311. The second rotatable shaft 311 is configured to couple to the multiple speed gearbox 302.

Still referring to FIG. 9, in some embodiments, the multiple speed gearbox 302 is provided with a number of clutches including a low-forward mode clutch 312, a reverse mode clutch 313, a second-and-fourth mode clutch 314, a first-and-reverse mode clutch 315, and a third-and-fourth mode clutch 316. The low-forward mode clutch 312, the reverse mode clutch 313, and the third-and-fourth mode clutch 314 are operably coupled to the second rotatable shaft 311. In some embodiments, the multiple speed gearbox 302 includes a second planetary gear set 317. The second planetary gear set 317 is configured as a dual pinion compound planetary gear set. The second planetary gear set 317 has a second ring gear 318, a set of short pinion gears 319, a set of long pinion gears 320, a second sun gear 321, and a third sun gear 322. In some embodiments, the set of short pinion gears 319 shares a planet carrier with the set of long pinion gears 320. The set of short pinion gears 319 is coupled to the third sun gear 322. The set of long pinion gears 320 is coupled to the second sun gear 321. In some embodiments, the second sun gear 321 is coupled to the reverse mode clutch 313 and the second-and-fourth mode clutch 314. The third sun gear 322 is coupled to the low-forward mode clutch 312. In some embodiments, the third-and-fourth mode clutch 316 is coupled to the planet carrier of the second planetary gear set 317. The second ring gear 318 is operably coupled to a third rotatable shaft 323. The third rotatable shaft 323 is configured to transmit an output power.

Referring now to FIG. 10, during operation of the CVT 300 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 300. The table depicted in FIG. 10, lists the modes of operation for the CVT 300 and indicates with an “x” the corresponding clutch engagement or clutch position. For mode 1 operation, the low-forward mode clutch 312 and the first-and-reverse mode clutch 315 are engaged. For mode 2 operation, the low-forward mode clutch 312 and the second-and-fourth mode clutch 314 are engaged. For mode 3 operation, the low-forward mode clutch 312 and the third-and-fourth mode clutch 316 are engaged. For mode 4 operation, the second-and-fourth mode clutch 314 and the third-and-fourth mode clutch 316 are engaged. For reverse mode operation, the first-and-reverse mode clutch 315 and the reverse mode clutch 313 are engaged.

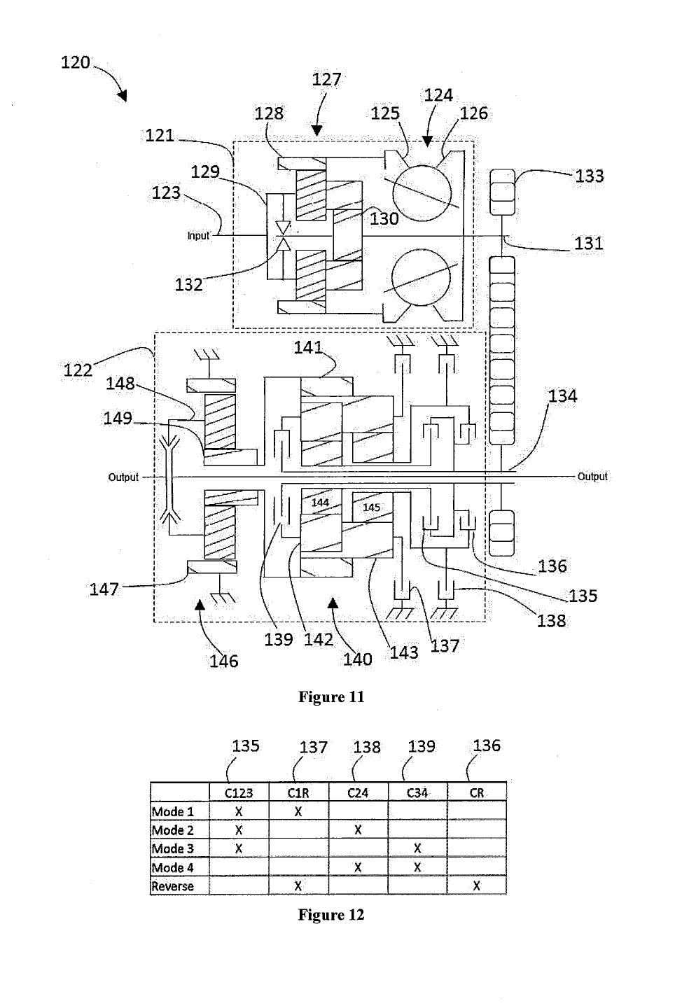

Turning now to FIG. 11, in some embodiments, a continuously variable transmission (CVT) 120 includes a continuously variable device 121 operably coupled to a multiple speed gearbox 122. The CVT 120 is provided with a first rotatable shaft 123 adapted to operably couple to a source of rotatable power (not shown). The continuously variable device 121 includes a variator 124 having a first traction ring assembly 125 and a second traction ring assembly 126. In some embodiments, the variator 124 is configured such as the variator depicted in FIGS. 1-3. The continuously variable device 121 includes a first planetary gear set 127 having a first ring gear 128, a first planet carrier 129, and a first sun gear 130. The first ring gear 128 is operably coupled to the first traction ring assembly 125. The first planet carrier 129 is operably coupled to the first rotatable shaft 123. The first sun gear 130 is operably coupled to the second traction ring assembly 126. In some embodiments, the first sun gear 130 is operably coupled to a second rotatable shaft 131. The second rotatable shaft 131 is configured to couple to the multiple speed gearbox 122. In some embodiments, the CVT 120 includes a locking clutch 132 operably coupled to the first planet carrier 129 and the first sun gear 130. The locking clutch 132 is configured to selectively couple the first planet carrier 129 to the first sun gear 130 during operation of the CVT 120 to thereby provide a fixed ratio mode of operation. Optional embodiments and methods for controlling the locking clutch 132 are described in U.S. Patent Application No. 62/333,632, which is hereby incorporated by reference.

Referring still to FIG. 11, in some embodiments, the CVT 120 includes a chain coupling 133 having a set of sprockets coupled by a chain. The chain coupling 133 is coupled to the second rotatable shaft 131 and a third rotatable shaft 134. The third rotatable shaft 134 is arranged parallel to the second rotatable shaft 131. The third rotatable shaft 134 is operably coupled to the multiple speed gearbox 122. In some embodiments, the multiple speed gearbox 122 is provided with a number of clutch devices including a low-forward mode clutch 135, a reverse mode clutch 136, a second-and-fourth mode clutch 137, a first-and-reverse mode clutch 138, and a third-and-fourth mode clutch 139. The low-forward mode clutch 135, the reverse mode clutch 136, and the third-and-fourth mode clutch 139 are operably coupled to the third rotatable shaft 134. In some embodiments, the multiple speed gearbox 122 includes a second planetary gear set 140. The second planetary gear set 140 is configured as a dual pinion compound planetary gear set. The second planetary gear set 140 has a second ring gear 141, a set of short pinion gears 142, a set of long pinion gears 143, a second sun gear 144, and a third sun gear 145. In some embodiments, the set of short pinion gears 142 shares a planet carrier with the set of long pinion gears 143. The set of short pinion gears 143 is coupled to the third sun gear 145. The set of long pinion gears 143 is coupled to the second sun gear 144. In some embodiments, the second sun gear 144 is coupled to the reverse mode clutch 136 and the second-and-fourth mode clutch 137. The third sun gear 145 is coupled to the low-forward mode clutch 135. In some embodiments, the third-and-fourth mode clutch 139 is coupled to the planet carrier of the second planetary gear set 140. The second ring gear 141 is operably coupled to a third planetary gear set 146. The third planetary gear set 146 includes a third ring gear 147, a third planet carrier 148, and a fourth sun gear 149. The second ring gear 141 is coupled to the fourth sun gear 149. The third ring gear 147 is coupled to a grounded member of the CVT 120, such as the housing (not shown). The third planet carrier 148 is adapted to transmit an output power to a final drive gear of the CVT 120.

Referring now to FIG. 12, during operation of the CVT 120 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 120. The table depicted in FIG. 12, lists the modes of operation for the CVT 120 and indicates with an “x” the corresponding clutch engagement or clutch position. For mode 1 operation, the low-forward mode clutch 135 and the first-and-reverse mode clutch 137 are engaged. For mode 2 operation, the low-forward mode clutch 135 and the second-and-fourth-mode clutch 138 are engaged. For mode 3 operation, the low-forward mode clutch 135 and the third-and-fourth mode clutch 139 are engaged. For mode 4 operation, the second-and-fourth mode clutch 138 and the third-and-fourth mode clutch 139 are engaged. For reverse mode operation, the first-and-reverse mode clutch 137 and the reverse mode clutch 136 are engaged.

In some embodiments, the locking clutch 132 is optionally configured to selectively engage during operation to provide a fixed ratio operating mode as an optional gear in any of the four modes of operation depicted in FIG. 12. During fixed ratio operating modes, power is transmitting through fixed gear ratios and the variator operates at a 1:1 speed ratio without transmitting any power. For example, engagement of the locking clutch 132 in mode 1 provides a fixed ratio for vehicle launch from a stop. The locking clutch 132 can be disengaged when a desired vehicle speed is reach and the vehicle continues to operate in mode 1 with power transmitted through the variator. The locking clutch 132 can be engaged during mode 2, mode 3, mode 4, or reverse operation to transmit power through fixed gear ratios and effectively bypass the variator.

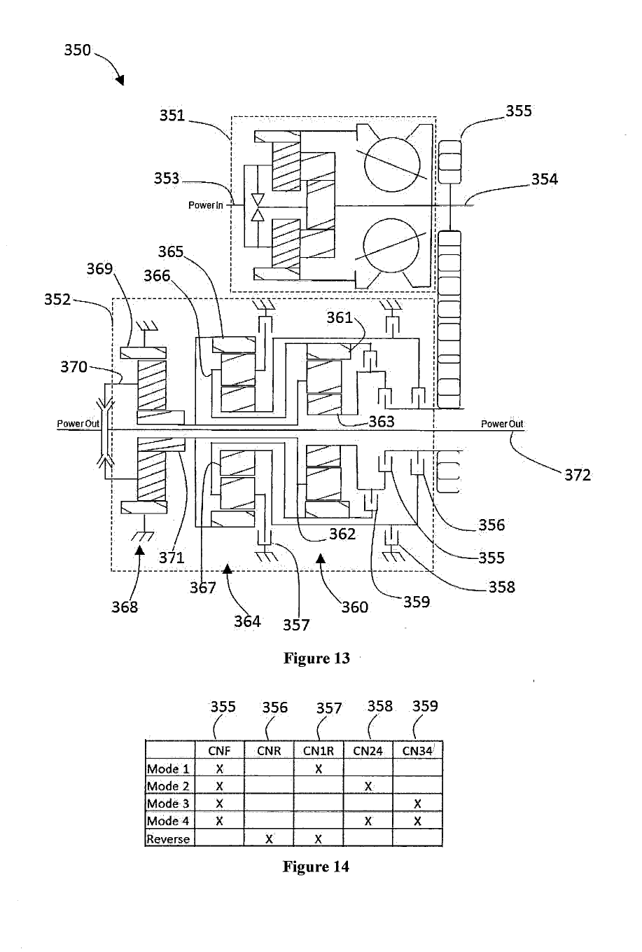

Referring now to FIG. 13, in some embodiments, a continuously variable transmission (CVT) 350 includes a continuously variable device 351 operably coupled to a multiple speed gearbox 352. For description purposes, only the differences between the CVT 350 and the CVT 120 will be described. In some embodiments, the continuously variable device 351 is configured in a similar manner as the continuously variable device 121. The CVT 350 includes a first rotatable shaft 353 adapted to couple to a source of rotational power (not shown). The continuously variable device 351 includes a second rotatable shaft 354 operably coupled to a chain coupling 355. The chain coupling 355 is adapted to couple the continuously variable device 351 to the multiple speed gearbox 352. In some embodiments, the multiple speed gearbox 352 is provided with a number of clutch devices including a forward mode clutch 355, a reverse mode clutch 356, a first-and-reverse mode clutch 357, a second-and-fourth mode clutch 358, and a third-and-fourth mode clutch 359.

In some embodiments, the multiple speed gearbox 352 includes a second planetary gear set 360. The second planetary gear set 360 has a second ring gear 361, a second planet carrier 362, and a second sun gear 363. In some embodiments, the second sun gear 363 is coupled to the third-and-fourth mode clutch 359. The third-and-fourth mode clutch 359 is operably coupled to the forward mode clutch 355. The second ring gear 361 is coupled to the third-and-fourth mode clutch 359. In some embodiments, the CVT 350 includes a third planetary gear set 364 having a third ring gear 365, a third planet carrier 366, and a third sun gear 367. The third sun gear 367 is coupled to the second-and-fourth mode clutch 358 and the reverse clutch 356. The third planet carrier 366 is coupled to the second ring gear 361. The third ring gear 365 is coupled to the second planet carrier 362. In some embodiments, the CVT 350 includes a fourth planetary gear set 368 having a fourth ring gear 369, a fourth planet carrier 370, and a fourth sun gear 371. The fourth ring gear 369 is operably coupled to a grounded member of the CVT 350. The fourth sun gear 371 is coupled to the third ring gear 365. The fourth planet carrier 370 is adapted to couple to an output drive shaft 372. The output drive shaft 372 is adapted to transmit an output power from the CVT 350.

Referring now to FIG. 14, during operation of the CVT 350 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 350. The table depicted in FIG. 14, lists the modes of operation for the CVT 350 and indicates with an “x” the corresponding clutch engagement or clutch position. For mode 1 operation, the forward mode clutch 355 and the first-and-reverse mode clutch 357 are engaged. For mode 2 operation, the forward mode clutch 355 and the second-and-fourth mode clutch 358 are engaged. For mode 3 operation, the forward mode clutch 355 and the third-and-fourth mode clutch 359 are engaged. For mode 4 operation, the forward mode clutch 355, the second-and-fourth mode clutch 358, and the third-and-fourth mode clutch 359 are engaged. For reverse mode operation, the first-and-reverse mode clutch 357 and the reverse mode clutch 356 are engaged.

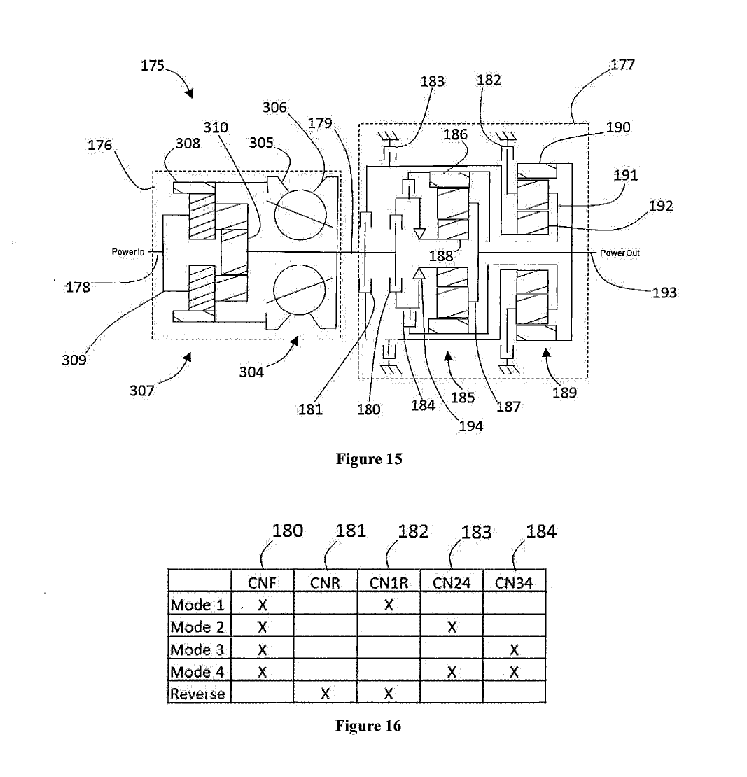

Referring now to FIG. 15, in some embodiments, a continuously variable transmission (CVT) 175 includes a continuously variable device 176 operably coupled to a multiple speed gearbox 177. For description purposes, only the differences between the CVT 175 and the CVT 90 will be described. In some embodiments, the continuously variable device 176 is configured in a similar manner as the continuously variable device 121. The CVT 175 includes a first rotatable shaft 178 adapted to couple to a source of rotational power (not shown). The continuously variable device 176 includes a second rotatable shaft 179 operably coupled to the multiple speed gearbox 177. In some embodiments, the multiple speed gearbox 177 is provided with a number of clutch devices including a forward mode clutch 180, a reverse mode clutch 181, a first-and-reverse mode clutch 182, a second-and-fourth mode clutch 183, and a third-and-fourth mode clutch 184.

In some embodiments, the multiple speed gearbox 177 includes a second planetary gear set 185. The second planetary gear set 185 has a second ring gear 186, a second planet carrier 187, and a second sun gear 188. In some embodiments, the second sun gear 188 is coupled to the third-and-fourth mode clutch 184 through a one-way clutch 194. The third-and-fourth mode clutch 184 is operably coupled to the forward mode clutch 180. The second ring gear 186 is coupled to the third-and-fourth mode clutch 184. In some embodiments, the CVT 175 includes a third planetary gear set 189 having a third ring gear 190, a third planet carrier 191, and a third sun gear 192. The third sun gear 192 is coupled to the second-and-fourth mode clutch 183 and the reverse clutch 181. The third planet carrier 191 is coupled to the second ring gear 186. The third ring gear 190 is coupled to the second planet carrier 187. The third ring gear 190 and the second planet carrier 187 are adapted to couple to an output drive shaft 193. The output drive shaft 193 is adapted to transmit an output power from the CVT 175.

Referring now to FIG. 16, during operation of the CVT 175 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 175. The table depicted in FIG. 16, lists the modes of operation for the CVT 175 and indicates with an “x” the corresponding clutch engagement or clutch position. For mode 1 operation, the forward mode clutch 180 and the first-and-reverse mode clutch 182 are engaged. For mode 2 operation, the forward mode clutch 180 and the second-and-fourth mode clutch 183 are engaged. For mode 3 operation, the forward mode clutch 180 and the third-and-fourth mode clutch 184 are engaged. For mode 4 operation, the forward mode clutch 180, the second-and-fourth mode clutch 183, and the third-and-fourth mode clutch 184 are engaged. For reverse mode operation, the first-and-reverse mode clutch 182 and the reverse mode clutch 181 are engaged.

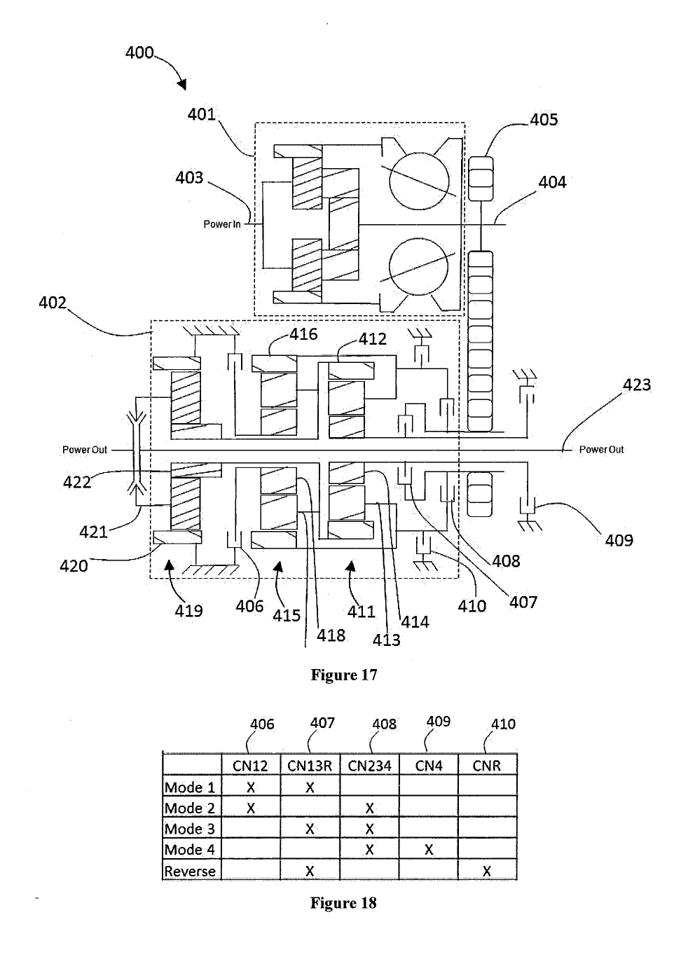

Referring now to FIG. 17, in some embodiments, a continuously variable transmission (CVT) 400 includes a continuously variable device 401 operably coupled to a multiple speed gearbox 402. For description purposes, only the differences between the CVT 400 and the CVT 175 will be described. In some embodiments, the continuously variable device 401 is configured in a similar manner as the continuously variable device 176. The CVT 400 includes a first rotatable shaft 403 adapted to couple to a source of rotational power (not shown). The continuously variable device 401 includes a second rotatable shaft 404 operably coupled to a chain coupling 405. The chain coupling 405 is configured to couple the second rotatable shaft 404 to the multiple speed gearbox 402. In some embodiments, the multiple speed gearbox 402 is provided with a number of clutch devices including a first-and-second mode clutch 406, a first-and-third mode clutch 407, a forward mode clutch 408, a fourth mode clutch 409, and a reverse mode clutch 410.

In some embodiments, the multiple speed gearbox 402 includes a second planetary gear set 411. The second planetary gear set 411 has a second ring gear 412, a second planet carrier 413, and a second sun gear 414. In some embodiments, the second planet carrier 413 is coupled to the forward mode clutch 408. The second sun gear 414 is coupled to the first-and-third mode clutch 407. In some embodiments, the chain coupling 405 is coupled to the forward mode clutch 408 and the first-and-third mode clutch 407. The reverse mode clutch 410 is operably coupled to the forward mode clutch 408 and the second planet carrier 413. In some embodiments, the CVT 400 includes a third planetary gear set 415 having a third ring gear 416, a third planet carrier 417, and a third sun gear 418. The third sun gear 418 is coupled to first-and-second mode clutch 406. The third planet carrier 417 is coupled to the second ring gear 412. The third ring gear 416 is coupled to the second planet carrier 413. In some embodiments, the CVT 400 includes a fourth planetary gear set 419 having a fourth ring gear 420, a fourth planet carrier 421, and a fourth sun gear 422. The fourth ring gear 420 is operably coupled to a grounded member of the CVT 400. The fourth sun gear 422 is coupled to the third planet carrier 417. The fourth planet carrier 421 is configured to couple to an output drive shaft 423.

Referring now to FIG. 18, during operation of the CVT 400 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 400. The table depicted in FIG. 18, lists the modes of operation for the CVT 400 and indicates with an “x” the corresponding clutch engagement or clutch position. For mode 1 operation, the first-and-second mode clutch 406 and the first-and-third mode clutch 407 are engaged. For mode 2 operation, the first-and-second mode clutch 406 and the forward mode clutch 408 are engaged. For mode 3 operation, the forward mode clutch 408 and the first-and-third mode clutch 407 are engaged. For mode 4 operation, the forward mode clutch 408 and the fourth mode clutch 409 are engaged. For reverse mode operation, the first-and-reverse mode clutch 407 and the reverse mode clutch 410 are engaged.

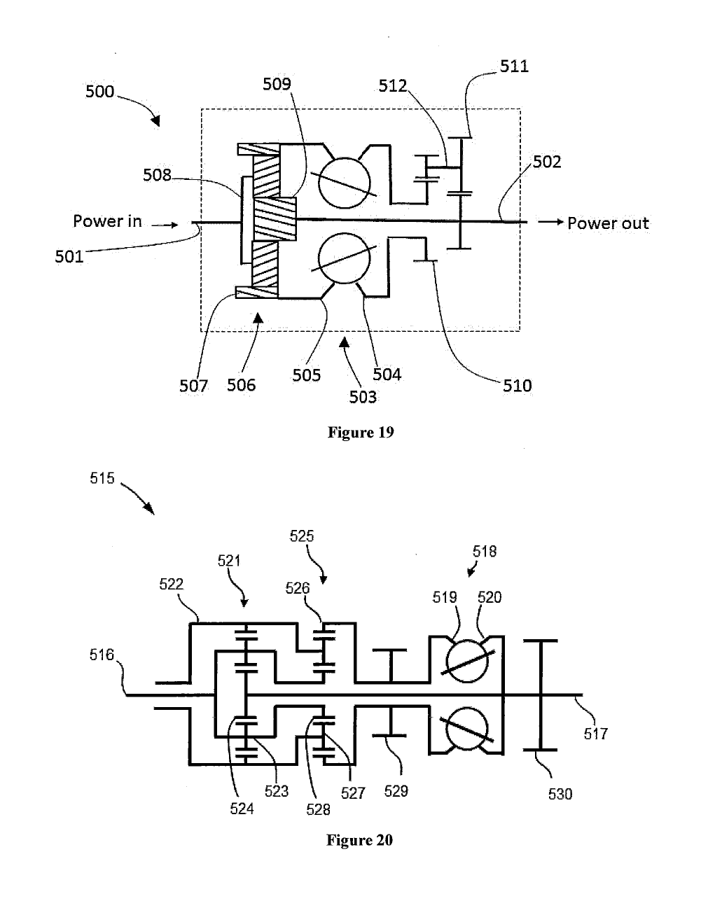

Turning now to FIG. 19, in some embodiments, a continuously variable device (CVD) 500 includes a first rotatable shaft 501 and a second rotatable shaft 502. The first rotatable shaft 501 and the second rotatable shaft 502 are coaxial and form a main axis of the CVD 500. The first rotatable shaft 501 is configured to couple to a source of rotational power (not shown). In some embodiments, the second rotatable shaft 502 is configured to transfer power out of the CVD 500, for example, to a gearbox or other downstream gearing. In some embodiments, the CVD 500 includes a variator 503 having a first traction ring assembly 504 and a second traction ring assembly 505. The variator 503 is substantially similar to the variator described in FIGS. 1-3. In some embodiments, the CVD 500 includes a planetary gear set 506 having a ring gear 507, a planet carrier 508, and a sun gear 509. The planet carrier 508 is operably coupled to the first rotatable shaft 501. The ring gear 507 is coupled to the second traction ring assembly 505. The sun gear 509 is coupled to the second rotatable shaft 502. In some embodiments, the first traction ring assembly 504 is coupled to a first gear set 510. The first gear set 510 is a fixed ratio gear set configured to transfer power to a second gear set 511 through a coupling 512. The second gear set 511 is coupled to the second rotatable shaft 502.

Turning now to FIG. 20, in some embodiments, a continuously variable device (CVD) 515 includes a first rotatable shaft 516 arranged coaxially with a second rotatable shaft 517 to form a main axis of the CVD 515. The first rotatable shaft 516 is configured to couple to a source of rotational power (not shown). The first rotatable shaft 516 is optionally configured to transfer power out of the CVD 515. In some embodiments, the second rotatable shaft 517 is configured to transfer power in or out of the CVD 515, for example, to a gearbox or other downstream gearing. In some embodiments, the CVD 515 includes a variator 518 having a first traction ring assembly 519 and a second traction ring assembly 520. The variator 518 is substantially similar to the variator described in FIGS. 1-3. In some embodiments, the CVD 515 includes a first planetary gear set 521 having a first ring gear 522, a first planet carrier 523, and a first sun gear 524. In some embodiments, the first ring gear 522 is optionally adapted to receive an input power or transfer power out of the CVD 515. The first planet carrier 523 is operably coupled to the first rotatable shaft 516. In some embodiments, the first sun gear 524 is operably coupled to the second rotatable shaft 517.

In some embodiments, the CVD 515 includes a second planetary gear set 525 having a second ring gear 526, a second planet carrier 527, and a second sun gear 528. The first ring gear 522 is coupled to the second planet carrier 527. The second ring gear 526 is coupled to the first traction ring assembly 519. The second sun gear 528 is coupled to the first planet carrier 523. In some embodiments, the CVD 515 includes a first transfer gear 529 operably coupled to the first traction ring assembly 519 and the second ring gear 526. The first transfer gear 529 is optionally adapted to provide a path to transfer rotational power in or out of the CVD 515. In some embodiments, the CVD 515 is provided with a second transfer gear set 530 operably coupled to the second traction ring assembly 520 and the second rotatable shaft 517. The second transfer gear set 530 is optionally adapted to provide a path to transfer rotational power in or out of the CVD 515.

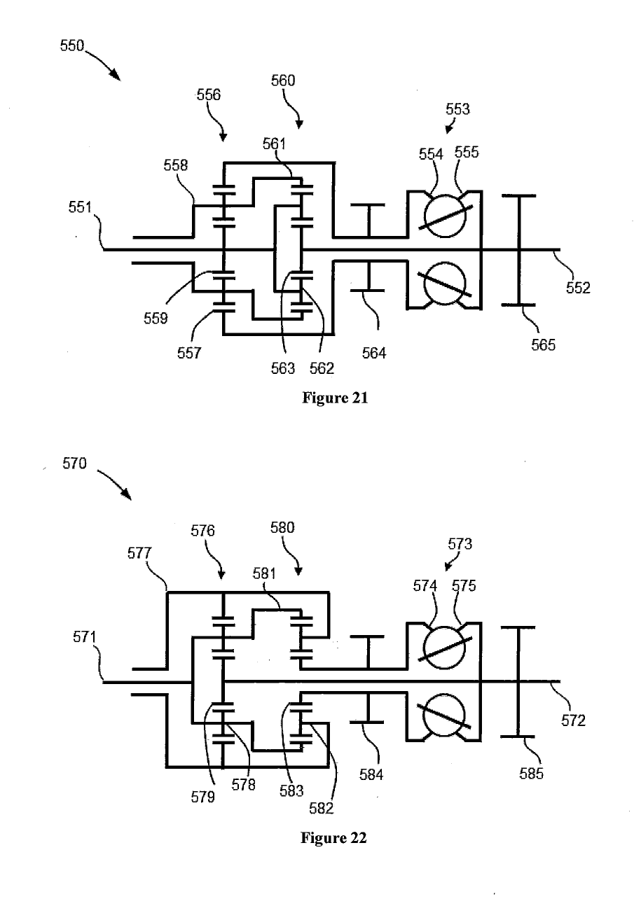

Passing now to FIG. 21, in some embodiments, a continuously variable device (CVD) 550 includes a first rotatable shaft 551 arranged coaxially with a second rotatable shaft 552 to form a main axis of the CVD 550. The first rotatable shaft 551 is configured to couple to a source of rotational power (not shown). The first rotatable shaft 551 is optionally configured to transfer power out of the CVD 550. In some embodiments, the second rotatable shaft 552 is configured to transfer power in or out of the CVD 550, for example, to a gearbox or other downstream gearing. In some embodiments, the CVD 550 includes a variator 553 having a first traction ring assembly 554 and a second traction ring assembly 555. The variator 553 is substantially similar to the variator described in FIGS. 1-3. In some embodiments, the CVD 550 includes a first planetary gear set 556 having a first ring gear 557, a first planet carrier 558, and a first sun gear 559. In some embodiments, the first planet carrier 558 is optionally adapted to receive an input power or transfer power out of the CVD 550. The first sun gear 559 is operably coupled to the first rotatable shaft 551. The first ring gear 557 is coupled to the first traction ring assembly 554. In some embodiments, the CVD 550 includes a second planetary gear set 560 having a second ring gear 561, a second planet carrier 562, and a second sun gear 563. The first sun gear 559 is coupled to the second planet carrier 562. The second ring gear 561 is coupled to the first planet carrier 558. The second sun gear 563 is coupled to the second rotatable shaft 552. In some embodiments, the CVD 550 includes a first transfer gear 564 operably coupled to the first traction ring assembly 554 and the first ring gear 557, The first transfer gear 564 is optionally adapted to provide a path to transfer rotational power in or out of the CVD 550. In some embodiments, the CVD 550 is provided with a second transfer gear set 565 operably coupled to the second traction ring assembly 555 and the second rotatable shaft 552. The second transfer gear set 565 is optionally adapted to provide a path to transfer rotational power in or out of the CVD 550.

Passing now to FIG. 22, in some embodiments, a continuously variable device (CVD) 570 includes a first rotatable shaft 571 arranged coaxially with a second rotatable shaft 572 to form a main axis of the CVD 570. The first rotatable shaft 571 is configured to couple to a source of rotational power (not shown). The first rotatable shaft 571 is optionally configured to transfer power out of the CVD 570. In some embodiments, the second rotatable shaft 572 is configured to transfer power in or out of the CVD 570, for example, to a gearbox or other downstream gearing. In some embodiments, the CVD 570 includes a variator 573 having a first traction ring assembly 574 and a second traction ring assembly 575. The variator 573 is substantially similar to the variator described in FIGS. 1-3. In some embodiments, the CVD 570 includes a first planetary gear set 576 having a first ring gear 577, a first planet carrier 578, and a first sun gear 579. The first planet carrier 578 is operably coupled to the first rotatable shaft 571. In some embodiments, the first ring gear 577 is optionally adapted to receive an input power or transfer power out of the CVD 570. The first sun gear 579 is operably coupled to the second rotatable shaft 572. In some embodiments, the CVD 570 includes a second planetary gear set 580 having a second ring gear 581, a second planet carrier 582, and a second sun gear 583. The first ring gear 577 is coupled to the second planet carrier 582. The second ring gear 581 is coupled to the first planet carrier 578. The second sun gear 583 is coupled to the first traction ring assembly 574. In some embodiments, the CVD 570 includes a first transfer gear 584 operably coupled to the first traction ring assembly 574. The first transfer gear 584 is optionally adapted to provide a path to transfer rotational power in or out of the CVD 570. In some embodiments, the CVD 570 is provided with a second transfer gear set 585 operably coupled to the second traction ring assembly 575 and the second rotatable shaft 572. The second transfer gear set 585 is optionally adapted to provide a path to transfer rotational power in or out of the CVD 570.

It should be noted that the description above has provided dimensions for certain components or subassemblies. The mentioned dimensions, or ranges of dimensions, are provided in order to comply as best as possible with certain legal requirements, such as best mode. However, the scope of the preferred embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A method for controlling a continuously variable transmission, the method comprising:
providing a continuously variable transmission comprising:
a first rotatable shaft operably coupleable to a source of rotational power, the first rotatable shaft forming a main axis;
a continuously variable device (CVD), wherein the CVD is a ball variator assembly having a first traction ring assembly and a second traction ring assembly in contact with a plurality of balls, wherein each ball of the plurality of balls has a tiltable axis of rotation and wherein the ball variator assembly is coaxial with the main axis;
a multiple speed gearbox having a number of selectable speed ranges;
a CVD ratio actuator operably coupled to the CVD; and
a gearbox actuation system operably coupled to the multiple speed gearbox;
coupling the gearbox actuation system to the CVD ratio actuator; and
coordinating a change in speed ratio of the CVD to a change in the gearbox actuation system.

2. The method of claim 1, further comprising the step of determining a slip condition of the multiple speed gearbox.

3. The method of claim 2, further comprising the step of determining a reaction torque on a carrier assembly of the CVD.

4. The method of claim 3, wherein coordinating a change in speed ratio further comprises providing a hydraulic control system, the hydraulic control system configured to provide a control pressure to the CVD ratio actuator and the gearbox actuation system.

5. The method of claim 4, wherein coordinating a change in speed ratio further comprises the step of adjusting a second hydraulic pressure delivered to the CVD ratio actuator based at least in part on a first hydraulic control pressure delivered to the gearbox actuation system.

6. A method of controlling a continuously variable transmission, the method comprising:
providing a continuously variable transmission comprising:
a first rotatable shaft operably coupleable to a source of rotational power, the first rotatable shaft forming a main axis;
a continuously variable device (CVD) having a first traction ring assembly and a second traction ring assembly in contact with a plurality of balls, wherein each ball of the plurality of balls has a tiltable axis of rotation and the CVD is coaxial with the main axis;
a multiple speed gearbox having a number of selectable speed ranges;
a CVD ratio actuator operably coupled to the CVD; and
a gearbox actuation system operably coupled to the multiple speed gearbox;
receiving a plurality of signals indicative of a current operational condition of the CVD and the multiple speed gearbox;
commanding a change in the operating condition of the multiple speed gearbox based at least in part on the plurality of signals received; and
commanding a change in the CVD operating condition based at least in part on the operating condition of the multiple speed gearbox.

7. The method of claim 6, wherein commanding a change in operation condition of the multiple speed gearbox further comprises the step of determining a slip condition of a clutch provided in the multiple speed gearbox.

8. The method of claim 7, wherein commanding a change in the CVD operating condition further comprises the step of applying a force to the CVD, the force being proportional to a control pressure of the gearbox actuation system.

9. The method of claim 8, wherein applying a force to the CVD further comprises the step of coupling the CVD ratio actuator to the gearbox actuation system.

10. The method of claim 9, wherein coupling the CVD ratio actuator to the gearbox actuation system further comprises configuring a hydraulic coupling between the CVD ratio actuator and the gearbox actuation system.

11. A continuously variable transmission comprising:
a first rotatable shaft operably coupleable to a source of rotational power;
a second rotatable shaft arranged parallel to the first rotatable shaft;
a variator assembly having a first traction ring assembly and a second traction ring assembly in contact with a plurality of balls, wherein each ball of the plurality of balls has a tiltable axis of rotation, the variator assembly is coaxial with the first rotatable shaft;
a first planetary gear set comprising a first ring gear operably coupled to the second traction ring assembly, a first planet carrier operably coupled to the first rotatable shaft and a first sun gear; and
a second planetary gear set comprising a second ring gear operably coupled to the second rotatable shaft, a second planet carrier operably coupled to the first traction ring assembly and a second sun gear operably coupled to ground.

12. The continuously variable transmission of claim 11, further comprising a multiple speed gearbox operably coupled to the second rotatable shaft.

13. The continuously variable transmission of claim 12, further comprising a first actuator operably coupled to the variator assembly, wherein the first actuator is configured to adjust the speed ratio of the variator assembly.

14. The continuously variable transmission of claim 13, further comprising a second actuator operably coupled to the multiple speed gearbox, wherein the second actuator is configured to selectively engage a plurality of clutches provided in the multiple speed gearbox.

15. The continuously variable transmission of claim 14, wherein the first actuator is operably coupled to the second actuator.

16. The continuously variable transmission of claim 15, wherein the first actuator is configured to apply a force on the variator assembly proportional to a control pressure of the second actuator.

17. A continuously variable transmission comprising:
a first rotatable shaft operably coupleable to a source of rotational power;
a second rotatable shaft arranged parallel to the first rotatable shaft;
a variator assembly having a first traction ring assembly and a second traction ring assembly in contact with a plurality of balls, wherein each ball of the plurality of balls has a tiltable axis of rotation, the variator assembly is coaxial with the first rotatable shaft;
a planetary gear set comprising a ring gear, a planet carrier operably coupled to the second traction ring assembly, and a sun gear operably coupled to the first traction ring assembly;
a first clutch coaxial with the second rotatable shaft, the first clutch operably coupled to the ring gear;
a second clutch coaxial with the second rotatable shaft, the second clutch operably coupled to the ring gear;
a third clutch coaxial with the second rotatable shaft, the third clutch operably coupled to the second clutch;
a fourth clutch coaxial with the second rotatable shaft;
a first gear set having a first fixed torque ratio, wherein the first gear set is coaxial with the second rotatable shaft and is operably coupled to the first clutch, the second clutch, and the fourth clutch; and
a second gear set having a second fixed torque ratio, wherein the second gear set is coaxial with the second rotatable shaft and is operably coupled to the first gear set and the third clutch.

18. The continuously variable transmission of claim 17, further comprising a third gear set operably coupled to the ring gear and the first clutch.

19. The continuously variable transmission of claim 18, further comprising a fourth gear set operably coupled to the first gear set.

20. The continuously variable transmission of claim 19, wherein the second clutch is configured to selectively engage a first power path and a second power path.

21. A continuously variable transmission comprising:
a first rotatable shaft operably coupleable to a source of rotational power;
a continuously variable device operably coupled to and coaxial to the first rotatable shaft, the continuously variable device comprising a ball variator assembly having a first traction ring assembly and a second traction ring assembly in contact with a plurality of balls, wherein each ball of the plurality of balls has a tiltable axis of rotation, the variator assembly is coaxial with the first rotatable shaft;
a second rotatable shaft coaxial with the first rotatable shaft operably coupled to the continuously variable device; and
a multiple speed gearbox operably coupled to the second rotatable shaft.

22. The continuously variable transmission of claim 21, wherein the continuously variable device further comprises a first planetary gear set, the first planetary gear set comprising:
a first ring gear coupled to the first traction ring assembly;
a first planet carrier coupled to the first rotatable shaft;
a first sun gear coupled to the second traction ring assembly; and
the second rotatable shaft.

23. The continuously variable transmission of claim 22, wherein the continuously variable device further comprises a locking clutch operably coupled to the first planetary gear set.

24. The continuously variable transmission of claim 23, wherein the locking clutch is coupled to the first sun gear and the first planet carrier.

25. The continuously variable transmission of claim 22, wherein the multiple speed gearbox further comprises:
a low-forward mode clutch;
a reverse mode clutch;
a third-and-fourth mode clutch;
a second-and-fourth mode clutch;
a first-and-reverse mode clutch; and
a second planetary gear set comprising a second ring gear, a second planet carrier configured to support a set of short pinion gears and a set of long pinion gears, a second sun gear coupled to the set of long pinion gears, and a third sun gear coupled to the set of short pinion gears,
wherein the low-forward mode clutch, the reverse mode clutch, and the third-and-fourth mode clutch are operably coupled to the second rotatable shaft,
wherein the second sun gear is coupled to the reverse mode clutch and the second-and-fourth mode clutch,
wherein the third sun gear is coupled to the low-forward mode clutch,
wherein the second planet carrier is coupled to the third-and-fourth mode clutch, and
wherein the second ring gear is adapted to transmit an output power from the multiple speed gearbox.

26. The continuously variable transmission of claim 22, wherein the multiple speed gearbox further comprises:
a forward mode clutch;
a reverse mode clutch;
a first-and-reverse mode clutch;
a second-and-fourth mode clutch;
a third-and-fourth mode clutch operably coupled to the forward mode clutch;
a second planetary gear set comprising a second ring gear, a second planet carrier, and a second sun gear, wherein the second sun gear is coupled to the third-and-fourth mode clutch, the second ring gear is coupled to the third-and-fourth mode clutch;
a third planetary gear set comprising a third ring gear, a third planet carrier, and a third sun gear, wherein the third planet carrier is coupled to the second ring gear, the third ring gear is coupled to the second planet carrier; and
a fourth planetary gear set comprising a fourth ring gear, a fourth planet carrier, and a fourth sun gear, wherein the fourth planet carrier is coupled to ground, the fourth sun gear is coupled to the third ring gear, and the fourth ring gear is adapted to transmit an output power from the multiple speed gearbox.

27. The continuously variable transmission of claim 22, wherein the multiple speed gearbox further comprises:
a first-and-second mode clutch;
a reverse mode clutch;
a first-and-third mode clutch;
a forward mode clutch operably coupled to the reverse mode clutch;
a fourth mode clutch;
a second planetary gear set comprising a second ring gear, a second planet carrier, and a second sun gear, wherein the second planet carrier is coupled to the forward mode clutch and the second sun gear is coupled to the first-and-third mode clutch;
a third planetary gear set comprising a third ring gear, a third planet carrier, and a third sun gear, wherein the third planet carrier is coupled to the second ring gear and the third ring gear is coupled to the second planet carrier; and
a fourth planetary gear set comprising a fourth ring gear, a fourth planet carrier, and a fourth sun gear, wherein the fourth planet carrier is coupled to ground, the fourth sun gear is coupled to the third planet carrier, and the fourth ring gear is adapted to transmit an output power from the multiple speed gearbox.

28. The continuously variable transmission of claim 25, further comprising a chain coupling configured to couple the second rotatable shaft to the multiple speed gearbox.

29. The continuously variable transmission of claim 26, further comprising a chain coupling configured to couple the second rotatable shaft to the multiple speed gearbox.

30. The continuously variable transmission of claim 27, further comprising a chain coupling configured to couple the second rotatable shaft to the multiple speed gearbox.
